(19) United States
(12) Patent Application Publication
(10) Pub. No.: US 2002/0052816 A1
(43) Pub. Date: May 2, 2002

(54) Method and apparatus for selling financial instruments

(76) Inventors: Stuart J. Clenaghan, London (GB); Timothy Wood, Trumbull, CT (US); Charles Stietzel, Stamford, CT (US); Tom Ineke, London (GB); David Soanes, London (GB); Bin Ji, Stamford, CT (US)

Correspondence Address: Clifford Chance Rogers & Wells LLP, 200 Park Avenue, New York, NY, 10166, US

(21) Appl. No.: 09/750,417

(22) Filed: Dec. 27, 2000

Related U.S. Application Data
(60) Provisional application No. 60/173,274, filed on Dec. 28, 1999.

(51) Int. Cl. G06F 17/60

(52) U.S. Cl. 705/36

(57) ABSTRACT

Computer processing of order data received at a computer system in connection with the sale and purchase of debt instruments in a primary market includes automatically adjusting an order size based on a investor-specified demand curve for a debt instrument and a market value that established subsequent to the receipt of the purchase order. The demand quantity can be specified by a collection of discrete data sets, each including a market value and a demand quantity at that market value. A dynamically updated order book that aggregates the received orders to distinguish demand for the debt instrument at different market values can be displayed to an issuer and used to establish the market value of the debt instrument. The order book may be updated upon request during a subscription period for the debt instrument to enable access to an updated status of orders placed for the issue. Purchases may be automatically transacted using swaps to satisfy payment obligations for received allocations of the new issue. Filtered views of available issues can be presented to investors; the filtered views taking into account restrictions that may prevent an investor from participating in particular offers (e.g., geographic and regulatory restrictions).

### CROSS-REFERENCE(S) TO RELATED APPLICATIONS

This application claims the benefit of the filing date of U.S. provisional application serial No. 60/173,274 entitled “Method and Apparatus For Selling Financial Instruments” which was filed on Dec. 28, 1999.

### BACKGROUND OF THE INVENTION

A number of parties are involved in the issuance and sale of government bonds, corporate notes and other fixed-income securities (collectively, “debt instruments”). These parties include the issuer, primary market investors, and secondary market investors. Different rules and procedures for the issuance of the debt instrument are applicable to each of these parties and each party has different information needs and restrictions.

The issue of a bond or other debt instrument typically begins with an initial offering of the instrument to primary market investors. During this issue phase, also known as a subscription period, primary market investors place orders for the debt instrument with one or more agencies managing the issue of the instrument. These agencies typically include investment banks and brokerage agencies. During the subscription period, the market value of the bond may be undetermined, though investors can typically estimate the value based on experience in the valuation of similar instruments. The market value may then be set by the issuer at the end of the subscription period based on all of the offers that were received. Following the initial issue of the debt instrument in the primary market sale, the instrument may be traded in the secondary market.

Electronic trading systems exist to help issuers, primary market investors, and secondary market investors sell debt instruments. Such systems may operate as on-line bulletin boards listing available offers and inviting investors to call a particular managing entities. More sophisticated systems provide for more fully automated on-line trading of the debt instruments. Advantages can be gained by further improvements in the information handling, presentation, and processing capabilities of on-line debt instrument trading systems.

### SUMMARY OF THE INVENTION

In general, in one aspect, the invention features variable adjustment of an order size for a debt instrument based on a market value of the debt instrument. The invention features receiving order data at the server during a subscription period. The order data request purchase of a debt instrument (i.e., an initial subscription to a debt instrument such as a fixed-income security, a municipal or corporate bond, etc.). The order data specifies a non-zero order size that can vary based on the market value that is established for the debt instrument (a variable non-zero size is distinct from the sizes applicable to an ordinary limit order which either zero or a single non-zero size order results). This feature enables the investor to construct a demand curve for a debt instrument. After the market value of the debt instrument is established (e.g., by the issuer selecting a favorable price upon close of the subscription period), the actual size can be determined for the order.

Implementations may include one or more of the following features. The order data can specify a zero order size for a second range of market values; if the zero order size range is not explicitly specified it may implicitly include all market values less favorable than the least favorable value associated with the non-zero order size range. Market values may be specified in a number of different ways, including as a percentage of the par value of the debt instrument, based on the coupon value of the debt instrument, as a spread or as a yield to maturity. The non-zero demand quantity may be specified by a collection of discrete data sets. Each data set includes a market value and a demand quantity at that market value. In some implementations, demand also may be specified using a formula. Other relationships between market value and demand can also be used.

In general, in another aspect, the invention features the display of an updateable order book to an issuer of a debt instrument. The invention includes receiving order request at a server and aggregating the request to form an order book. Each order request specifies a desired quantity of an issue of a debt instrument. The aggregate of these request (i.e., the order book) can differentiate total purchase demand at different market values of the debt instrument. The order book can be displayed to an issuer of the debt instrument upon request from that issuer.

Implementations may include one or more of the following features. Each order request may specify a market value and an order size. The order book can be updated by aggregating the order request (i.e., summing order sizes for different market values) as the orders are received at the server, upon request by the issuer to view the order book, or at other times. In some implementations, an order book displayed at a issuer's computer may be automatically updated as new orders are received at the server. This automatic updating may be provided, e.g., using a Java applet that periodically queries the server for updated information.

In general, in another aspect, the invention enables new issues of a debt instrument to be purchased based on the value of a swap transaction. The invention includes receiving order data at a server from a purchaser. The order data includes a request for purchase of a debt instrument to issue to primary market investors. The purchase order data identifies a swap instrument and the server can automatically transact a purchase of the debt instrument using the swap instrument to satisfy a payment obligation for the debt instrument. In some cases, the swap instrument may also be a debt instrument. The system enables a secondary-market exchange of this swap instrument.

In general, in another aspect, the invention provides for filtered views of a new issue offering database. The invention includes storing data describing financial instrument issuance offers and availability restrictions associated with each of the offers. A database is also used to store investor data that identifies restrictions associated with each investor. A filtered view of the offer database can be generated and presented to an inventor based on the offer availability restrictions associated with the financial instrument issuance offers and the investor data identifying restrictions associated with a first one of the investors. The availability restrictions may be based on the investor's geographic location. For example, certain offers may be valid in limited geographic regions. Restrictions may also be based on other factors such as regulatory requirement limiting qualified investors (e.g., offers may be limited to section 144 investors).

In general, in another aspect, the invention features a hierarchical structure of issuer, managing entity, and investor accounts associated with an issue of a debt instrument. An issuer account is established at a server. The issuer account provides a means by which the issuer accesses and manages information about a debt instrument being issued by that issuer. Management accounts are also established at the server for each of a group of managing entities (e.g., a management account may be established for each of a group of investment banks). Each management account allows for the creation of sub-accounts. The sub-account are used by primary market investors to access the system and place orders for the debt instrument. The system receives offers for purchase of the debt instrument from the primary market investors and can generate an issuer order book by aggregating the offers. The issuer order book can be displayed to the issuer, while restricting its presentation to the managing entities and investors. This may be done to prevent access by managing entities to the customer (i.e., investor) data, orders, and proprietary information stored on behalf of other managing entities. In some case managing entity order books are also generated. Each managing entity order book is associated with one of the managing entities and contains an aggregate of orders generated through investor sub-accounts established by that managing entity.

The inventions, summarized above, are exemplary of those set forth in the accompanying drawings and the description below. Other features, objects, and advantages of the invention will be apparent from the description and drawings, and from the claims.

### DESCRIPTION OF THE DRAWINGS

FIG. 1 is a system architecture diagram.

FIGS. 2-6 are images of web pages generated by the system 110 of FIG. 1.

### DETAILED DESCRIPTION OF THE INVENTION

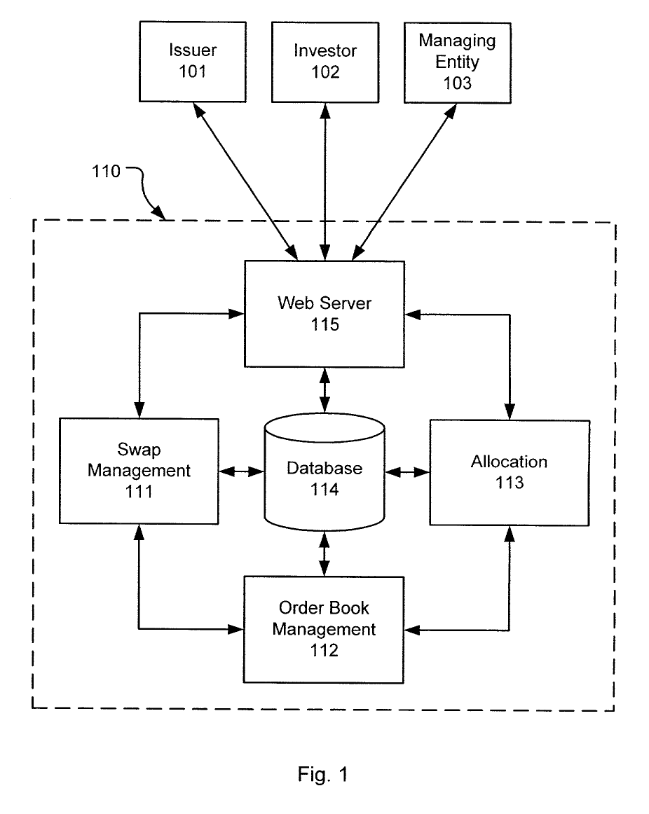

FIG. 1 shows a system architecture 100 of a client-server computer system usable for on-line listing and sale of bonds and other debt instruments (for example, fixed income securities, government bonds, and corporate bonds). The system 100 can be implemented using web-based protocols to gives investors on-line access to new debt instrument issues and to allow submission of orders using web browsers connections over the Internet or other computer network. The system 100 can provide a range of information services to issuers, investors, managing entities, and other primary market participants, and can provide up-to-date information about pending debt instrument issue. By way of example, an implementation of the system 100 directed to bond issues will now be described.

The trading system 100 includes a server 110 connected over a network to client terminals 101-103. The server 110 provides data storage and transaction processing functions accessible to users at the terminals 101-103. The functions provided by the server 110 can assist the users in the purchase and sale of bonds in a primary market. Primary market sales are a distinct sales type requiring specialized trading system features. For example, in the primary market, the market value of instruments being issued may be undetermined during the subscription period; the server 110 can provide features to assist bond issuers and investors in assessing the value of a bond being issued and to help ensure appropriate order sizing and execution. Implementations may allow an investor to specify an order size for the bond based on a demand curve so that the order size can vary with a market value established at the end of the subscription period. Other features of the system 100 include the generation of order books that are updated on request to show the current status of a new issue subscription and the use of swaps for the purchase of a new issue.

The server 110 includes a number of different functional components 111-115 to process and store data received from the terminals 101 -103. The functional components 111-115 may be implemented on a single computer system or in a distributed fashion (i.e., the functionality of components 111-115 can be provided by a combination of computer processing systems and database servers). Components of the system 110 can be implemented using commercially available software systems customized in accordance with the disclosure herein. For example, the web server 115 may be a implemented using the Microsoft Internet Information Server application on a Windows 2000 platform. The database 114 can be an Oracle 8i database, an IBM DB2, a Microsoft SQL 2000, or other database system.

Implementations of system 110 may include additional components found in conventional trading systems. For example, the system 110 may include an order management system, a portfolio management system, an accounting system, and a trade reconciliation system. These additional components may be provided through commercially available software components or custom developed. For example, an accounting system may be implemented using third-party accounting software such as the Geneva account system produced by Advent Software, Inc.

Prior to a bond issue, login accounts may be established on the system 110 for the issuer, managing entities such as the lead underwriter, as well as for the primary market investors. These different types of accounts are arranged in a hierarchical structure, with different levels of the hierarchy having different access to order information (levels higher in the hierarchy exercising control over lower levels of the hierarchy). Typically, investor accounts will be at a relatively low level of this hierarchy. Investor accounts provide investors with functions to enter orders and to modify and view details of that investor's orders. Investor's accounts allows little or no access to the details of other investor's accounts and orders.

In some implementations, managing entity accounts can be established at a hierarchical level higher than the investor accounts. Managing entity accounts are associated with managing entities such as investment banks and underwriters. A managing entity can access a managing entity account to establish investor accounts; the investor accounts are thereby associated with a particular managing entity and activities of particular investors may be accessible by that managing entities. A managing entity can access order details generated through the entity's established investor sub-accounts, but not information in other managing entity's investor sub-accounts. Similarly, issuer account can be established at a hierarchical level higher than the managing entity accounts. The issuer's account allows access to all information relative to submitted orders from investors and managing entities. In so doing, the issuer's account provides up to data, aggregated information about the status of a pending bond issue.

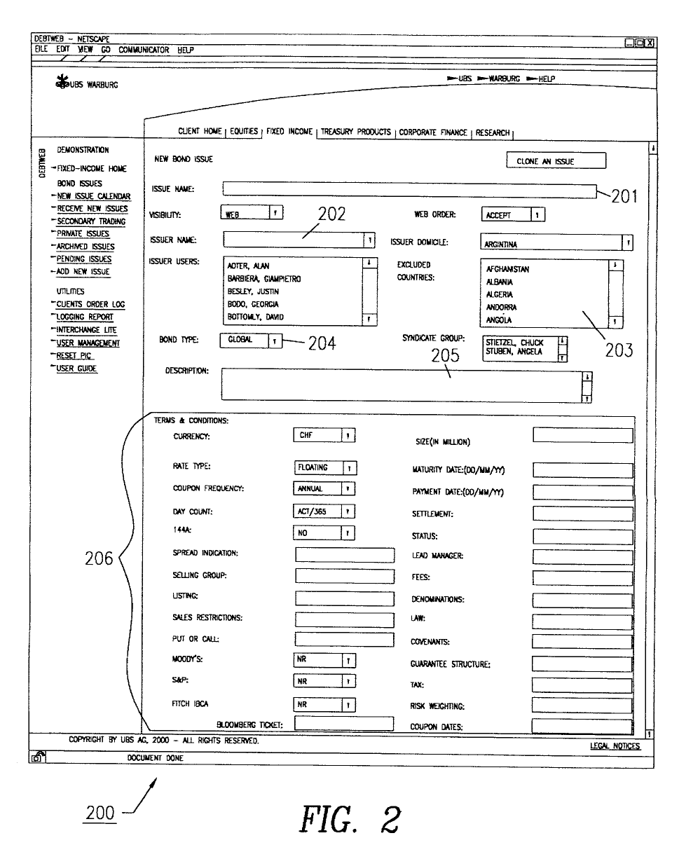

The bond issue process begins with entry of the details of a bond offer by an issuer and storage of the received offer details in the database 114. FIG. 2 shows a web form 200 that can be displayed by the system 110 on the issuer's computer terminal 101. The web form 200 allows the issuer to enter all pertinent details of the debt instrument. These details include, among other things, the bond issue name 201, issuer name 202, countries in which the offer is not valid 203, bond type 204, description 205, and terms and conditions 206 associated with the bond issue. After the form 200 is completed by the issuer, it is posted to the web server 115, time-stamped, and then stored in a new issue database 114. Thereafter, details of the new bond issue can be viewed by potential inventors.

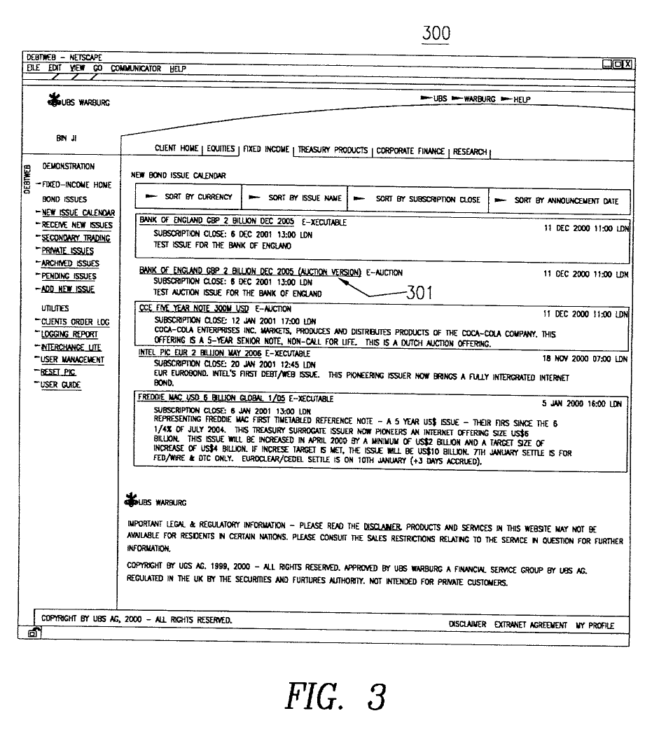

Investor's can view details of new issues on a new issue calendar 300 (FIG. 3). The new issues calendar displays new issues, the subscription period for those issues, and the subscription means (i.e., whether offers can be submitted via the system 110 or by traditional means such as phoning an investment bank). To generate the issue calendar 300, the system 110 queries the database 114 to access data about available and ongoing debt instrument issues, and then filters the results based on any restrictions associated with the user. For example, if a particular issue is unavailable in certain countries (e.g., as specified by the excluded countries data 203), and the investor is located in one of those countries, the investor will not see that issue's data. Similarly, if the issue is a Section 144A issue (specified in the data 206), and the investor is not a qualified Section 144A investor, the investor will not see the issue's data. After the system 110 generates the new issue calendar, it is transmitted to the investor's terminal 102 and displayed. The investor may thereafter select an issue name, e.g., name 301 (or other display element formatted as a hypertext link) to obtain full details of an issue from the server 110. Other details also may be available from a new issue calendar (or other web page generated by the system 110). For example, the calendar 300 can include a “Prospectus” link to download an issuer's prospectus, a “pricing Supplement” link to download a pricing supplement, and a “Commentary” link to access market commentary.

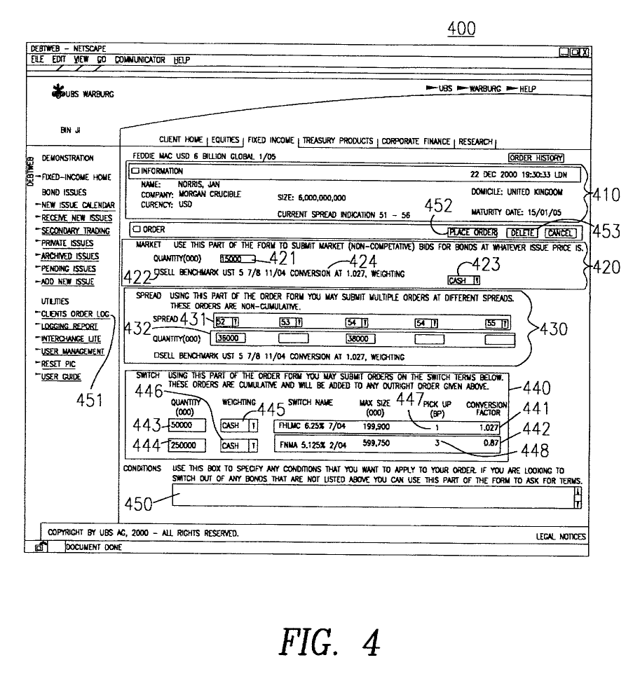

To place an order for an issue on the calendar 300, the investor may select a link displayed on the calendar 300 or otherwise access an order form from the server 110. FIG. 4 shows an exemplary order form. The form 400 includes information about the investor 410 (which may be obtained from investor account data stored in the database 114), and data fields 420, 430, 440 used to input an order. The form allows different order types to be input. For example, fields 420 are used to enter a market order, fields 430 are used to enter a spread order, and fields 430 are used to enter a switch order (also referred to as a swap order).

A market order 410 is a non-competitive order that is used when the investor wants to subscribe for bonds at the to-be-established market value (i.e., the price at which the investor subscribes is set in the context of the market). To purchase bonds using a market order, the investor enters the quantity 421 of the purchase. The investor can choose to sell the benchmark (e.g., a United States Treasury, “UST”) on a cash-for-cash or a duration-weighted basis by ticking the “sell benchmark” box 422 and selecting Cash or Duration from the dropdown box 423. The conversion factor for duration weighted trades is indicated 424.

Investors may also choose to submit orders on a spread basis. A spread order allows an investor to specify a demand curve for a purchase (the term “demand curve,” as used herein, does not imply a smooth curve but may include discrete steps as is the case for the data in 430). The specified demand curve can be used to automatically vary the order size depending on the established market value. The spread order data 430 allows an investor to specify a demand curve based on a series of spread values 431. For each spread value in the series 431, a separate demand quantity 432 can be specified. For example, as shown by 431 and 432, at a spread value of +52 points above benchmark (i.e., a yield of 0.52% greater than a benchmark bond), the investor's demand is $36,000,000 and at a spread of +54 points above benchmark, the investor's demand is $38,000,000. Thus, the data 431-432 is used to specify a non-zero order size that can vary based on the market value that is established for the debt instrument. In some implementations, demand also may be specified using a formula. Although the data 431 expresses market value in terms of yield versus a benchmark instrument, the market value also may be specified in other ways such as a percentage of the par value of the debt instrument, based on the coupon value of the debt instrument, as a spread or as a yield to maturity.

After the market value of the debt instrument is established (e.g., by the issuer selecting a favorable price upon close of the subscription period), the actual demand size associated with a particular spread order is determined by the system 110 based on the data 431-432 for that order. If the bond pricing is on more favorable terms (i.e., at a higher yield) than the order spread range, the investor's order will apply in the size of his/her offer under the most favorable conditions specified. In the example above, if the bond priced at +55 points (0.55% yield) greater than a baseline bond then the investor's order size will be $38,000,000. If final pricing comes at a less favorable (i.e., higher price/lower yield), than the least favorable terms specified (in this case, less than a +52 point yield), the investor will not get allocated bonds. Thus, an established market value less favorable than the least favorable terms specified by the investor are treated as a range of market values in which the investor's order size is zero.

An investors also can also submit switch (i.e., swap) orders. A switch order is an order for the new issue in which the purchase value for the new issue is satisfied by trading an existing instrument for the new issue. The data 440 may list proposed switch transactions 441 and 442 and, if the terms of these transactions interest the investor, the investor can accept a proposed transaction by entering quantity 443-444 and weighting 445-446 data (e.g., to specify a cash-for-cash or a duration weighted basis for the swap). Additional details of the proposed switch transaction 441-442 may also be available from the system. In FIG. 4, the proposed swaps are shown as 409-410. The maximum switch size 447-448 adjust as orders are placed. Thus, the system can automatically apply the market value of a debt instrument (in this case, the switch of a FHLMC 6.25% 7/04 or of a FHLMC 5.125% 2/04 bond, 441-442, respectively) to offset a purchase price of the issuing debt instrument.

If an investor submits a combination of order types (i.e., a combination including two or more of a market order 420, a spread order 430, and switch orders 440) then the orders are cumulative. Each order will add together so that an investor may apply for bonds at market level, on a price spread basis, and against switch. The order form also includes a free-text field 450 in which the investor can specify special conditions that apply to their order. Orders can be amended throughout the subscription period right up until the books are closed. An investor can amend an order by accessing the ‘Order Log’ 451 or by reentering the deal from the New Issue Calendar 300. The order can be amended or deleted 453 and re-submitted to the system. To submit an order, the investor selects the “Place Order” button 452.

As order data is received from the investors (i.e., during the new issue subscription period), the system 110 stores the order data in the database 114. Upon request by an issuer, this order data can be aggregated by the order book management module 112 to form an updated issuer's order book which may then be provided by the web server 115 for display at the user terminal. To update the issuer's order book, the order book module 112 aggregates order data (i.e., the data received from form 400) such that the issuer may view currently placed orders at different price levels.

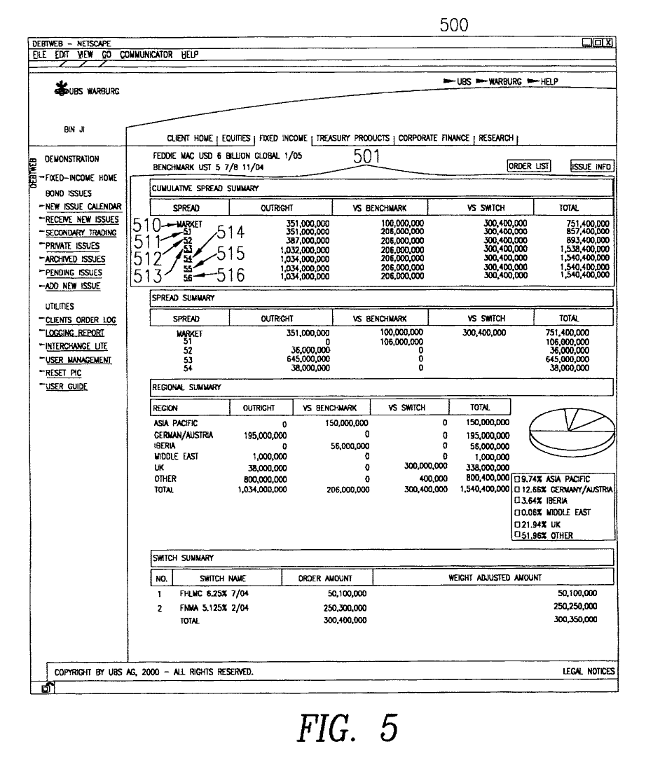

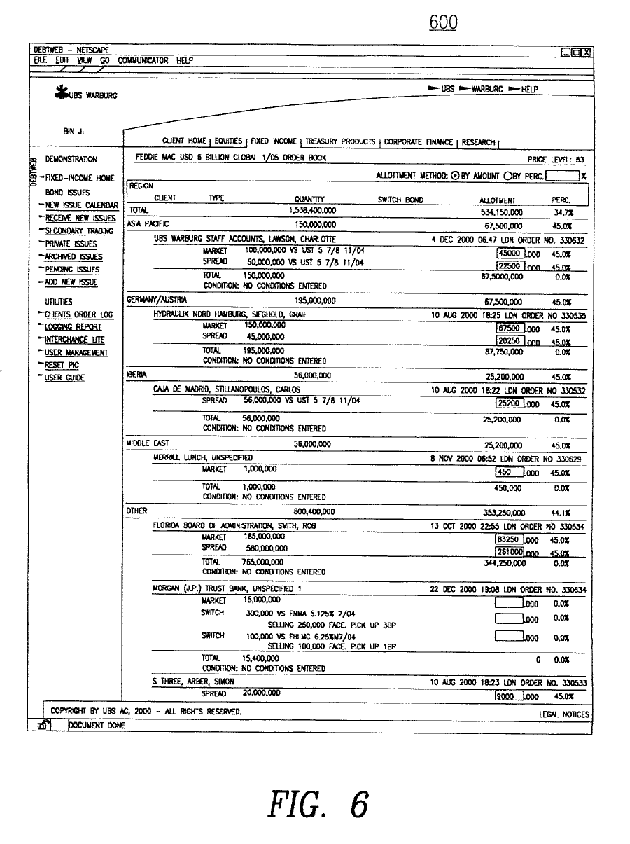

FIG. 5 shows a summary view of an issuer's order book and FIG. 6 shows a detailed view of the order book. The summary order book 500 shows a cumulative summary 501 of all market orders 510 and spread orders 511-516 entered by all investors. For example, referring to row 516, the issuer can see that if the bond is offered at a relatively favorable yield of 0.56% above the benchmark (a relatively favorable yield), the total order size is $1,540,400,000 ($1,034,000,000 in outright sales, $206,000,000 versus benchmark, and $300,400,000 in swap sales). On the other hand, referring to row 511, if the bond is offered at a less unfavorable yield of 0.51% above the benchmark, the total order size is $857,400,000 ($351,000,000 outright, $206,000,000 vs. the benchmark, and $300,400,000 versus switch offers). Each of the displayed summaries 510-516 may also function as a hypertext link. Selecting a link 510-516 obtains a detailed listing of the orders from the system 110. For example, when the link x0513 is selected, the system 110 generates the detailed view 600 (FIG. 6) and provides it to the issuer's terminal 101. The order books 500 and 600 may be generated on-demand by the issuer (i.e., at each request for their display).

In implementations supporting hierarchical arrangements of user accounts (e.g., investor-managing entity-issuer hierarchy disclosed, above), the order book management functionality 112 may similarly generate order books associated with particular managing entities. Each managing entity order book aggregates order details from investors associated with a particular managing entity and excludes order details for investors associated with other managing entities. Thus, the server 110 is configured to prevent access to each managing entity's order book by other managing entities (similarly, the server 110 is configured to prevent access to the issuer order book by the managing entities). These restrictions may be imposed to prevent improper access to customer data, orders, and proprietary information generated by investors. Likewise, order books may be generated and displayed to a particular investor to show orders placed by that investor.

Upon close of the subscription period, the issuer reviews the submitted orders to finalize the market value of the debt instrument. In some cases, an underwriter or issuer may retain the right to cancel the sale if the quantity of bonds requested by all orders is less than the amount being offered. In such a situation, if the sale is not canceled, all investors will receive 100% of the bonds requested. Another situation that can exist is where the quantity of bonds requested by all orders exceeds the amount being offered. In this case, an allocation of the offered bonds must occur. The allocation process divides the offered bonds among the purchasers. System 110 can include an automated order allocation component 113 that determines each investor's allocation of the available debt instruments. The component 113 can implement various allocation processes. An example allocation process follows.

After the subscription period ends, each order is broken down into order components. The order components include, e.g., market, switch and competitive order components (corresponding to data entries 420, 430, and 440). One market component may exist per order. There can be multiple switch components per order (i.e., one for each switch 441 and 442 offered by the underwriters). For allocation purposes, switch components are treated as market components. A competitive component is the incremental demand of the spread order 420 at the specified spread 431. There can be multiple competitive components per order up to a predefined maximum (in the example, 430, a predefined maximum of five). For example, consider the following order (corresponding to the data entries shown in FIG. 4, and where the abbreviation ‘M’ means millions of dollars):

Market: 15M,

Spread: 36M@52; 38M@54.

Switch: 30M vs. FHLMC 6.25% 7/04;

250M vs. FNMA 5.125% 2/04

This order consists of the following five order components:

1) a 15M Market Component,

2) a 30M Switch Component vs. FHLMC 6.25% 7/04,

3) a 250M Switch Component vs. FNMA 5.125% 2/04,

4) a 26M Competitive Component @52, and

5) a 38M Competitive Component @54.

The order components are ordered from lowest to the highest spread component starting with non-competitive order components (market and switch). The lowest spread level that results in the total quantity of bonds requested being greater than or equal to the total quantity of bonds being offered is called the “clearing spread” and can be determined automatically by the system or by the user based on the summary data shown in FIG. 5. After the clearing spread is determined, the allocation process is as follows:

1. Non-competitive order components and competitive components at spreads less than the clearing spread will be allocated at 100%. This is called the initial allocation. If the total demand in non-competitive order components is greater than or equal to the number of bonds offered, then the bonds will be allotted at the minimum spread level and only non-competitive order components will be considered for allocation. In this scenario, the number of bonds allocated in the initial allocation is zero. All order components at the clearing spread (or simply non-competitive order components if demand fulfilled by them) are filled based on time stamp from the earliest order placed to the last order received.

2. If the aggregate demand of order components at the clearing spread before the initial cutoff is greater than or equal to the number of bonds remaining after the initial allocation, then all order components placed before the initial cutoff are allocated on a pro rata basis. All order components placed at the clearing spread after the initial cutoff will not be allocated bonds.

3. If the aggregate demand of order components at the clearing spread before the initial cutoff is less than the number of bonds remaining after the initial allocation, then the order components are allocated at 100% in time stamp order. When the number of bonds remaining is less than or equal to the number of bonds demanded in a single order component, the order component will be allocated all of the remaining bonds. All other order components will receive no allocation. All investors with allocated order components will receive the bonds at the clearing spread.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments of the present invention have been described. Nevertheless, it will be understood that various modifications may be made without departing from the spirit and scope of the invention. Accordingly, other embodiments are within the scope of the following claims.

What is claimed is:

1. A computer-implemented method of processing order data associated with an issue of a debt instrument, the method comprising:
at a server, receiving a plurality of orders requesting purchase of a debt instrument, at least a first one of the orders comprising size data specifying a non-zero order size that varies over a first range of potential market values of the debt instrument;
establishing a market value of the debt instrument based on the plurality of orders; and
determining an order size for the first order based on the established market value and the size data.

2. The method of claim 1 wherein:
each of the plurality of orders comprises at least one order components selected from the group consisting of a market order component, a spread order component comprising said size data specifying said non-zero order size, and a switch order component; and
the method further comprises:
allocating an available allotment of the debt instrument among the plurality of orders by:
ranking order components associated with the plurality of orders,
determining a clearing spread associated with the ranked order components,
for each order components at a spread less than the clearing spread, allocating the debt instrument at a demand size specified by the respective order component, and
for each order components at a spread greater than the clearing spread, allocating the debt instrument based on a time-stamp associated with the respective order component.

3. The method of claim 1 wherein the first order further comprises a market value specifier selected from the group consisting of a percentage of par, a coupon value, a spread value, and a yield to maturity.

4. The method of claim 1 wherein the size data comprises a plurality of data sets, each data set comprising a market value and a demand quantity at said market value, and the plurality of sets representing a demand curve.

5. The method of claim 4 wherein determining the demand amount comprises determining based on the data sets.

6. A computer-implemented method of processing order data associated with issue of a debt instrument in a primary market, the method comprising:
during a subscription period for a debt instrument, receiving at a server a plurality of order request for an issue of the debt instrument;
during the subscription period, forming an order book comprising an aggregate of the plurality of order request received at the server, the aggregate differentiating total purchase demand for different market values of the debt instrument;
displaying the order book to an issuer of the debt instrument;
upon request by the issuer, forming an updated order book; and
displaying the updated order book to the issuer.

7. The method of claim 6 wherein each order request comprises a market value and an order size.

8. The method of claim 6 wherein forming an updated order book comprises updating the aggregate of the plurality of order request.

9. The method of claim 6 wherein the aggregate of the order request comprises a sum of demand at a plurality of different price ranges.

10. A computer-implemented method of processing purchase order data associated with an issue of a debt instrument, the method comprising:
receiving order data at an server from a purchaser, the order data requesting purchase of a debt instrument to issue in a primary market, the purchase order data further comprising an identification of a first swap instrument;
automatically transacting a purchase for the debt instrument using the first swap instrument to satisfy a payment obligation for the purchase of the debt instrument.

11. The method of claim 10 wherein:
the first swap instrument comprises a second debt instrument; and
using the first swap instrument to satisfy a payment obligation comprises exchanging the first swap instrument in a secondary market and applying a value of the first swap instrument received o offset a purchase price of the issuing debt instrument.

12. The method of claim 10 further comprising:
displaying at the client terminal identifications of a plurality of swap instruments selectable by an investor; and wherein
the identification of the first swap instrument comprises an identification of one of the plurality of swap instruments selected by the investor.

13. A computer-implemented method of processing data associated with an issue of a financial instrument, the method comprising:
storing offer data in a first database, the offer data describing a plurality of financial instrument issuance offers and availability restrictions associated with each of the financial instrument issuance offers;
storing investor data in a second database, the investor data comprising data identifying restrictions associated with each of a plurality of investors;
generating a filtered view of the first database based on the offer availability restrictions associated with the financial instrument issuance offers and based on investor data in the second database identifying restrictions associated with a first one of the investors;
presenting the filtered view to the first one of the investors.

14. The method of claim 13 wherein the availability restrictions comprise a geographic region in which financial instrument issuance offers are valid.

15. The method of claim 14 wherein the availability restriction comprises a regulatory requirement restricting qualified investors.

16. The method of claim 14 wherein the investor data identifying restrictions comprises a investor location associated with the first investor.

17. The method of claim 16 wherein generating the filtered view comprises omitting offers that are not valid for the investor location from the filtered view of the first database.

18. A computer-implemented method of processing order data associated with an issue of a debt instrument, the method comprising:
at a server, establishing an issuer account associated with an issuer of a debt instrument;
at the server, establishing a plurality of management accounts each associated with a different one of a plurality of managing entities and each enabling establishment of sub-accounts, each sub-account associated with a primary market investor for the debt instrument;
at the server, receiving requests from the managing entities to establish sub-accounts for primary market investors;
receiving offers from the primary market investors for purchase of the debt instrument;
generating an issuer order book comprising an aggregate of the offers received from the different primary market investors associated with the plurality of management accounts;
displaying the issuer order book to the issuer;

19. The method of claim 18 wherein the server is configured to prevent access to the issuer order book by the managing entities and by the investors.

20. The method of claim 19 further comprising:
generating a plurality of managing entity order books each corresponding to one of the managing entities and each comprising an aggregate of the offers received from primary market investors associated with said one of the managing entities;
displaying managing entity order books to the associated managing entity; and
preventing access by managing entities to managing entity order books associated with other ones of the managing entities.

21. A computer-implemented method of processing order data associated with an issue of a debt instrument, the method comprising:
receiving at a server a plurality of offers for purchase of a debt instrument, at least one of the offers specifying a demand amount that is variable based on market value of the debt instrument;
forming a dynamically updated order book comprising an aggregate of the plurality of offers, the aggregate differentiating total purchase demand at different purchase price levels; and
displaying the dynamically updated order book to an issuer of the debt instrument.

22. The method of claim 21 wherein a second one of the offers comprises an identification of a swap instrument and the method further comprises;
establishing a value of the swap instrument, the value being usable to satisfy a payment obligation associated with a purchase of the debt instrument in accordance with the second offer.

23. The method of claim 22 wherein the first and the second offers are the same offer.

24. The method of claim 22 further comprising:
at the server, establishing an issuer account associated with an issuer of the debt instrument;
at a server, establishing a plurality of management accounts each associated with a different one of a plurality of managing entities and each enabling establishment of sub-accounts, each sub-account associated with a primary market investor for the debt instrument;
at the server, receiving requests from the managing entities to establish sub-accounts for primary market investors;
receiving from the primary market investors the plurality of offers;
generating an issuer order book comprising an aggregate of the offers; and
displaying the issuer order book to the issuer.

25. A computer system for processing data in support of the issue of debt instruments in a primary market, the system comprising:
a network interface operatively coupling the system to a plurality of primary market investor terminals;
a data processor operatively coupled to the network interface and to a transaction database system; and
a program storage media coupled to the processor and comprising instructions to configure the processor to:
receive debt instrument purchase orders from the primary market investor terminals, at least a first one of the purchase orders comprising data specifying a non-zero order size that varies over a first range of market values of the debt instrument;
store purchase order data derived from received purchase orders in the transaction database system;
aggregate the stored purchase order data to distinguish market demand for the debt instrument at a plurality of potential market values;
establish a market value of the debt instrument based on the market demand at the plurality of potential market values; and
determine the order size associated with the first one of the purchase orders based on the established market value.

26. The system of claim 25 wherein the transaction database system comprises a database system selected from the group consisting of an in-memory database, a distributed database, a relational database, and a flat-file stored on a disk media.

27. The system of claim 25 wherein the first purchase order further comprises data specifying a zero order size for a second range of market values.

28. The system of claim 25 wherein the data specifying the non-zero order size comprises a plurality of data sets, each data set comprising a market value and a demand quantity at said market value, and wherein the instructions to configure the processor comprise instructions to vary the order size based on the plurality of data sets.

29. The system of claim 25 wherein
the instructions to aggregate the purchase order data comprise instructions to format the aggregated purchase order data for presentation to an issuer; and
the instructions to establish a market value comprise instructions to present the aggregated purchase order data to an issuer and instructions to receive a selection of a market value in response to the presentation of the aggregated purchase order data.

30. The system of claim 30 wherein the aggregate of the order data comprises a sum of demand at a plurality of different price ranges.

31. The system of claim 25 wherein at least a second one of the purchase orders comprise data specifying a swap transaction for the purchase of the debt instrument.

32. The system of claim 25 wherein:
the transaction database system further comprises data describing a plurality of financial instrument issuance offers and availability restrictions associated with each of the financial instrument issuance offers;
the system further comprises an investor database comprising data identifying restrictions associated with each of a plurality of investors; and
the instructions to configure the processor further comprises instructions to generate a filtered view of the offer database based on the offer availability
restrictions associated with the financial instrument issuance offers and the investor data identifying restrictions associated with a first one of the investors, and
present the filtered view to the first one of the investors.

33. The system of claim 32 wherein the instructions to receive purchase orders comprise instructions to receive from the first investor subsequent to execution of the instructions to present the filtered view to the first investor.

34. The system of claim 32 wherein the availability restrictions comprise a geographic region associated in which financial instrument issuance offers are valid.

35. The system of claim 32 wherein the instructions to generate the filtered view comprises instructions to omit from the filtered view of the offer database ones of the plurality of offers that are not valid for the investor location.

36. The system of claim 32 wherein
at least a first one of the purchase offer comprises data specifying a demand amount that is variable based on market value of the debt instrument; and
the instructions to configure the processor further comprise instructions to:
form a dynamically updated order book comprising an aggregate of the plurality of offers, the aggregate differentiating total purchase demand at different purchase price levels;
display the order book to an issuer of the debt instrument;
receive data indicating a market value for the debt instrument in response to display of the order book; and
the instructions to establish the market value comprise instructions to establish based on the receipt of the data indicating the market value.

37. The system of claim 36 wherein the instructions to configure the processor further comprises instructions to:
establishing a value of a swap instrument identified in a received purchase order; and
apply the value of the swap instrument to a payment obligation arising in accordance with said received offer.

38. The system of claim 26 wherein the instructions to configure the processor further comprising instructions to
establish an issuer account associated with an issuer of the debt instrument;
establish a plurality of management accounts each associated with a different one of a plurality of managing entities and each enabling establishment of sub-accounts, each sub-account associated with a primary market investor for the debt instrument;
receive requests from the managing entities to establish sub-accounts for primary market investors;
generate an issuer order book comprising an aggregate of the purchase orders;
displaying the issuer order book to the issuer but not to the managing entities;
generate a plurality of managing entity order books each corresponding to a managing entities and each comprising an aggregate of purchase orders received from primary market investors associated with said one of the managing entities;
display the managing entity order books to the associated managing entity; and
prevent access by managing entities to managing entity order books associated with other ones of the managing entities.
